(19) United States
(12) Patent Application Publication
(10) Pub. No.: US 2008/0290659 A1
(43) Pub. Date: Nov. 27, 2008

(54) HIGH PRESSURE HOSE WITH TWO-PART COMPOSITE CONNECTOR FITTINGS

(75) Inventors: Gus Alexander, Inverness, IL (US); Morgan McCarthy, Hoffman Estates, IL (US); John Pianetto, Hoffman Estates, IL (US)

Correspondence Address: LEYDIG VOIT & MAYER, LTD, TWO PRUDENTIAL PLAZA, SUITE 4900, 180 NORTH STETSON AVENUE, CHICAGO, IL, 60601-6731, US

(73) Assignee: FAIP North America, Inc., Elk Grove Village, IL (US)

(21) Appl. No.: 12/119,007

(22) Filed: May 12, 2008

Related U.S. Application Data
(60) Provisional application No. 60/928,863, filed on May 11, 2007.
(60) Provisional application No. 61/041,954, filed on Apr. 3, 2008.

(51) Int. Cl. F16L 13/14

(52) U.S. Cl. 285/382.1

(57) ABSTRACT

A coupling fitting for high pressure hose is provided. The coupling fitting includes a stem portion made of metallic material for connection to the high pressure hose. A coupling head made of a non-metallic material is connected to an end of the stem portion. The coupling head is configured for connection with a complementary fitting.

### CROSS-REFERENCE TO RELATED APPLICATIONS

This patent application claims the benefit of U.S. Provisional Patent Application No. 60/928,863, filed May 11, 2007, and U.S. Provisional Patent Application No. 61/041,954, filed Apr. 3, 2008, both of which are incorporated by reference.

### FIELD OF THE INVENTION

This present invention relates generally to hose coupling fittings, and more particularly, to fittings for high pressure hose, such as fittings that are used to connect hose to pressure washers and other high pressure liquid directing or spray devices, such as spray guns, wands, or the like.

### BACKGROUND OF THE INVENTION

Hose fittings, such as shown in U.S. Pat. No. 6,779,745 assigned to the same assignee as the present invention, are well known for connecting high pressure hose to high pressure liquid supplies and/or directing devices. Such fittings typically comprise an upstream stem with ribs adapted for force fit mounting within the hose and an outwardly extending coupling head for insertion into a fitting of the liquid supply or directing device. The coupling head typically carries one or more o-rings for providing a liquid seal between the coupling head and the mating fitting of the device to which it is coupled.

Such hose fittings, while seemingly simple in design, are relatively costly to manufacture. Such fittings typically are machined from metal to precision tolerances. O-rings and their assembly on the fitting add further costs. O-rings also are susceptible to failure or wear and periodically must be replaced. While forming the fittings from die cast metal is more economical, die cast metal surfaces are relatively rough and can require further machine finishing. Since the coupling head of the fitting must be compatible with the fitting of the liquid supply or directing device to which it is to be coupled, it also often must be custom manufactured for customer's particular needs, which necessitates the manufacture and inventorying of a relatively large number of different fitting designs.

### OBJECTS AND SUMMARY OF THE INVENTION

It is an object of the present invention to provide a high pressure hose fitting that is adapted for economical manufacture and more versatile and reliable usage.

A further object is to provide a hose fitting as characterized above that includes a standard stem and a coupling head that can be economically produced on a customized basis for compatibility with fittings of customer's liquid supply and/or directing devices.

A further object is to provide a high pressure hose fitting of the foregoing type which lends itself to manufacture by more economical metal die casting.

Still another object is to provide a high pressure hose fitting of the foregoing type which eliminates the need for o-rings and their costly replacement.

Yet a further object is to provide such a high pressure hose fitting which more effectively accommodates wear during usage.

Another object is to provide a method of making such composite high pressure hose fitting.

Other objects and advantages of the invention will become apparent upon reading the following detailed description and upon reference to the drawings, in which:

### BRIEF DESCRIPTION OF THE DRAWINGS

FIG. 1 is an exploded perspective of a pressure washer and spray gun interconnected by high pressure hose having fittings in accordance with the present invention;

FIG. 2 is an enlarged fragmentary section of one of the high pressure hose fittings, taken in the plane of line 2-2 in FIG. 1;

FIG. 3 is an enlarged perspective of the hose fitting shown in FIG. 2;

FIG. 4 is a longitudinal perspective section of the hose fitting shown in FIG. 3;

FIG. 5 is a perspective of an alternative embodiment of overmolded coupling head for a hose fitting in accordance with the invention;

FIG. 6 is a longitudinal section of the overmolded coupling head shown in FIG. 5; and

FIGS. 7-12 are alternative embodiments of hose fittings in accordance with the invention.

While the invention is susceptible of various modifications and alternative constructions, certain illustrative embodiments thereof have been shown in the drawings and will be described below in detail. It should be understood, however, that there is no intention to limit the invention to the specific form disclosed, but on the contrary, the intention is to cover all modifications, alternative constructions, and equivalents falling within the spirit and scope of the invention.

### DESCRIPTION OF THE PREFERRED EMBODIMENTS

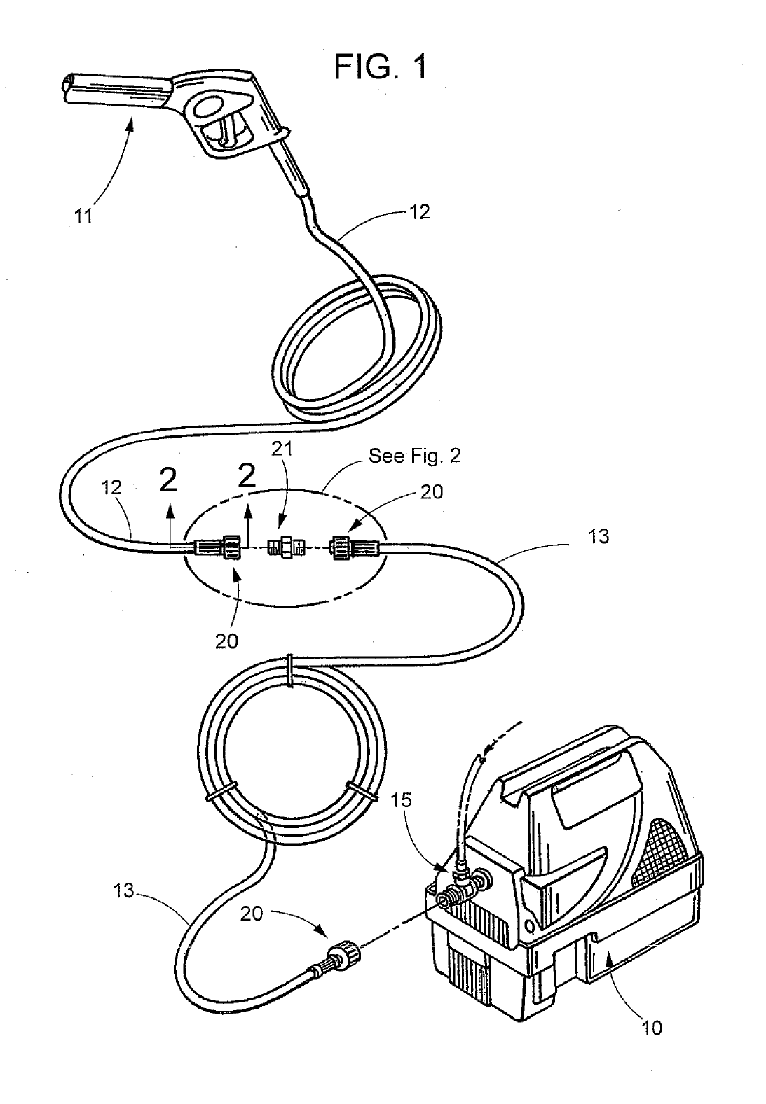

Referring now more particularly to FIG. 1 of the drawings, there is shown an illustrative high pressure hydraulic system which includes a pressure washer 10, a spray gun 11 having a flexible high pressure hose 12, and an extension hose 13 connected between the pressure washer 10 and the spray gun hose 13. The illustrated spray gun 11 is permanently secured to the downstream end of the hose 12, which like the extension hose 13, may be of a flexible reinforced construction of a known type suitable for withstanding liquid pressures generated by the pressure washer 10. The pressure washer 10 also may be of a known type with a gasoline or electric powered motor for operating a pump to generate a high pressure liquid discharge through a conventional outlet fitting 15 of the pressure washer 10.

For enabling connection of the spray gun hose 12 to the extension hose 13, or directly to the pressure washer outlet fitting 15, the spray gun hose 12 has a fitting 20 fixedly secured to the upstream end thereof. The extension hose 13 comprises a length of similar high pressure hose with connecting fittings 20 at its opposite ends which are identical in construction to the spray gun hose fitting 20. The fitting 20 of the spray gun hose 12 in this case is connected to the extension hose 13 by a conventional coupling adapter 21. It will be understood that the pressure washer 10, including the spray gun 11, extension hose 13, coupling adapter 21, and the basic function of the fittings 20, is similar to that disclosed in the aforementioned U.S. Pat. No. 6,779,745, the disclosure of which is incorporated by reference. Moreover, since the fittings 20 according to the invention are identical in construction, only one need be described herein in detail.

In accordance with an important aspect of the invention, the fittings have a novel two-part composite construction which lends itself to economical customized manufacture and reliable usage. According to one preferred embodiment, each fitting has a portion made of a metallic material and a portion made of a non-metallic material. The non-metallic material can be a plastic material. As will be appreciated by those skilled in the art, plastic materials generally have a lower cost as compared to most metals and thus the ability to make a portion of the hose fitting out of a plastic material can substantially reduce the cost of the fitting. The use of plastic for a portion of the hose fitting can also have aesthetic benefits in that metals can rust or corrode over time when they are exposed to the liquids discharged by the pressure washer. Another benefit of the use of plastic for a portion of the fitting is that plastics are easily produced in different colors. The ability to use different colors on the fittings enables them to be easily color coded based on particular properties such as size.

To this end, each fitting 20 comprises a universal metal stem 30 and an overmolded non-metallic coupling head 31. The illustrated stem 30 has a ribbed shank 32 that is forcibly positioned into the end of the hose 12 up to and against a radial locating flange 34 of the stem 30. For positively securing the stem 30 in the hose, an annular ferule 35 is crimped about an axle end of the hose and has an annular retaining flange 36 that is deformed into an annular retaining groove 33 of stem 30 immediately adjacent the locating flange 34. The hose fitting 20 may be connected to the pressure washer fitting 15, adapter 21, or the fitting of another high pressure liquid supply or connect directing device, by a retaining ring assembly 37 that is threadably engageable with an externally threaded end with the mating fitting for drawing the coupling head 31 into captive and secured relation within the mating fitting. The retaining ring 37 in this case comprises an outer plastic cover with an inner metal ring 38 that defines an annular lip 39 engageable with a radial retention flange 40 of the metal stem for secure positive engagement.

In keeping with the invention, the universal metal stem 30 may be economically manufactured from die cast metal and utilized without further finishing. While the finish of the metal cast stem 30 may be relatively rough, as compared to a machined metal part, the surface does not affect the functionality of the stem since the ribbed shank 32 is effective to sealingly engage and retain the stem 30 within the interior of the hose. The rigidity provided by the metal stem 30, including its annular retention flange 40, insures reliable securement with a mating fitting.

In carrying out the invention, the coupling head 31 of the fitting 20 is molded of a non-metallic material, which can be economically produced on a customized basis for use with the universal metal stem 30. The coupling head 31 preferably is made of a rubber or plastic material and can be custom designed and overmolded about an end of the stem 30 consistent with the design of a desired mating fitting. The couple head 31 may be molded of known thermoplastic or rubber materials including commercially available thermoplastic materials available under the trade names Santroprene® and Neoprene, NBR (natural butadiene rubber), PVC, HDPE, and HDPP. Other suitable materials include rigid polymers such as polyvinyl chloride with suitable additives. It will be understood that the invention is not limited to particular thermoplastic or rubber materials, and indeed, any material having suitable strength and sealing properties can be used in conjunction with the invention.

The coupling head 31 in this instance has a cylindrical hub portion 45 with an outwardly extending radial flange portion 46 adjacent the retaining flange 40 of the metal stem. The cylindrical hub portion 45 is formed with a pair of axially spaced annular grooves 48, 49 which each receive a respective sealing O-ring 50, 51. The O ring 50 in this case is smaller in diameter than the O ring 51 adjacent the axial end of the fitting for enabling the coupling head 31 of the fitting 20 to be utilized with multiple sized mating fittings, consistent with the disclosure of the afore-referenced U.S. Pat. No. 6,779,745. The coupling head hub portion 45 in this case has a forward chamfered annular end surface 52 for facilitating positioning of the coupling head in a mating fitting.

In further keeping with the invention, the stem 30 is designed to facilitate secure retention of the overmolded coupling head 31 during usage in which high pressure liquids are directed through the hose and fitting. In this case, the stem 30 is formed with a coupling head retention shank portion 55 extending axially from the retention flange 40 in a direction opposite to the rib shank 32 over which the non metallic coupling head 31 is molded. The coupling head retention shank portion 55 in this instance is formed with a plurality of axially spaced annular ribs or flutes 56, each oriented in a direction toward the retention ring 40, for retaining the overmolded coupling head 31 against axial forces in a direction away from the retention flange 40 of the metal stem. The retention shank portion 55 further is formed with at least one axially extending retention flange 58 about which the coupling head 31 is molded for securing the coupling head against relative rotational torque forces during usage. Hence, while the coupling head 31 is made of a non-metallic material, it will be appreciated by one skilled in the art that it is can be securely overmolded about the end of the stem 30.

It further will be appreciated by one skilled in the art that the universal metallic stem 30 can be economically produced, such as by die cast metal manufacture, without regard to the design of the fitting with which the stem is to be used. The overmolded coupling head 31, on the other hand, can be custom designed and economically produced by standard over molding procedures. Plastic has inherent cost advantages and provides a smooth, aesthetically attractive finished appearance without machining. Yet the universal metal stem insures rigidity and reliable coupling with a mating fitting for a long time reliable usage.

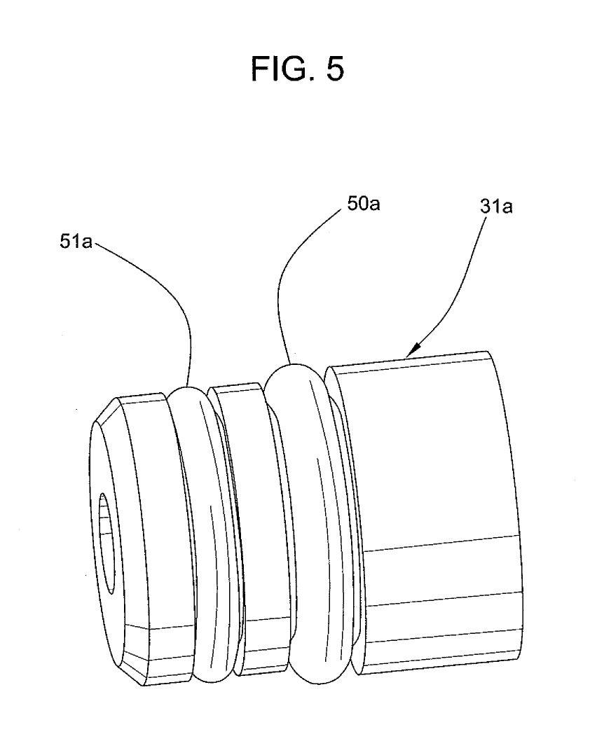

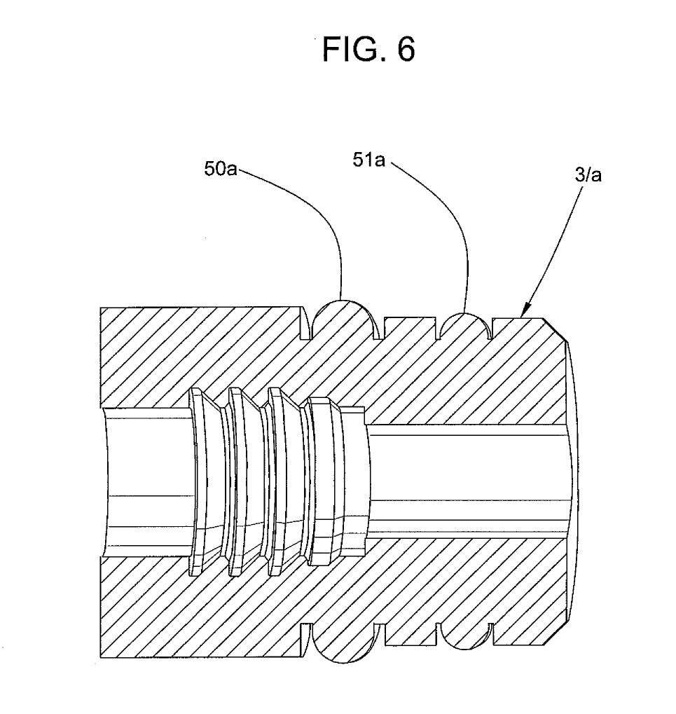

Referring now more particularly to FIGS. 5 and 6, there is shown and alternative embodiment of coupling head 31a that can be overmolded on the universal stem 30, which eliminates the necessity for separate O-rings. In this case, the coupling head 31a is molded with a pair of rounded simulated O-rings 50a, 51a, which are an integral part of the coupling head. The integrally molded simulated O-rings 50a, 51a provide the comparable sealing function. Not only do the simulated O-rings 50a, 51a eliminate the cost, handling, and replacement of separate O-rings, due to the inherent resiliency of the rubber or plastic material of the coupling head 31a, they have been found to provide good sealing and wear resistance.

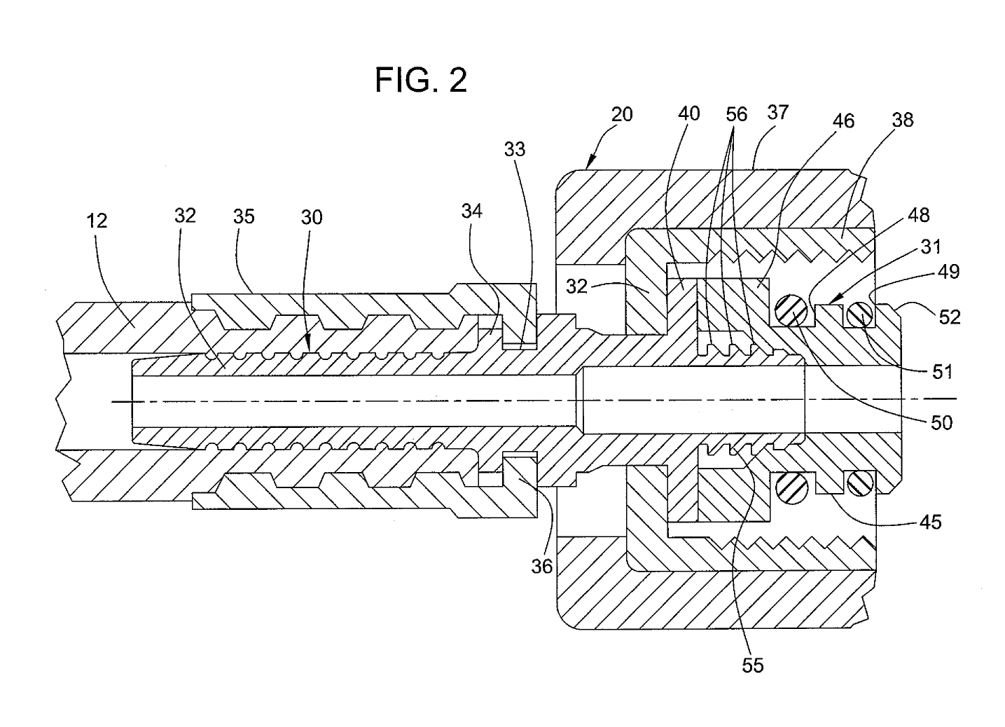

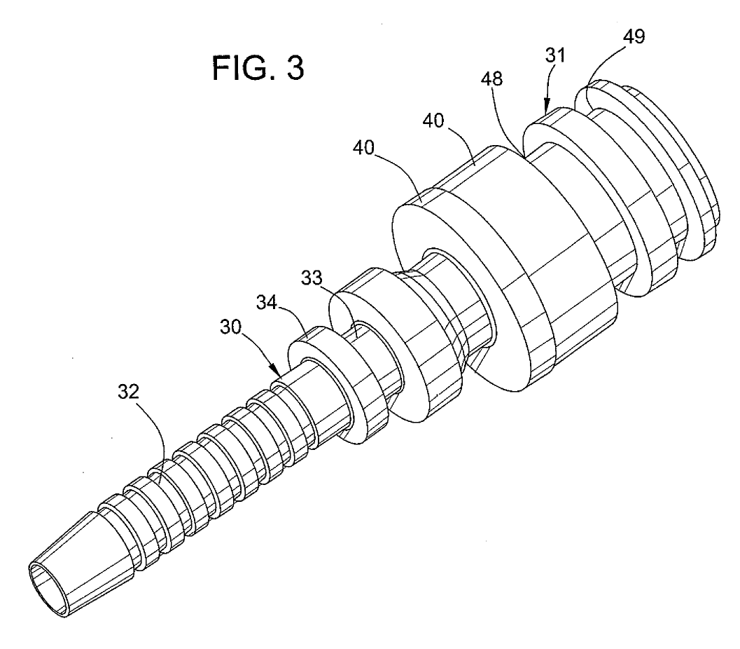

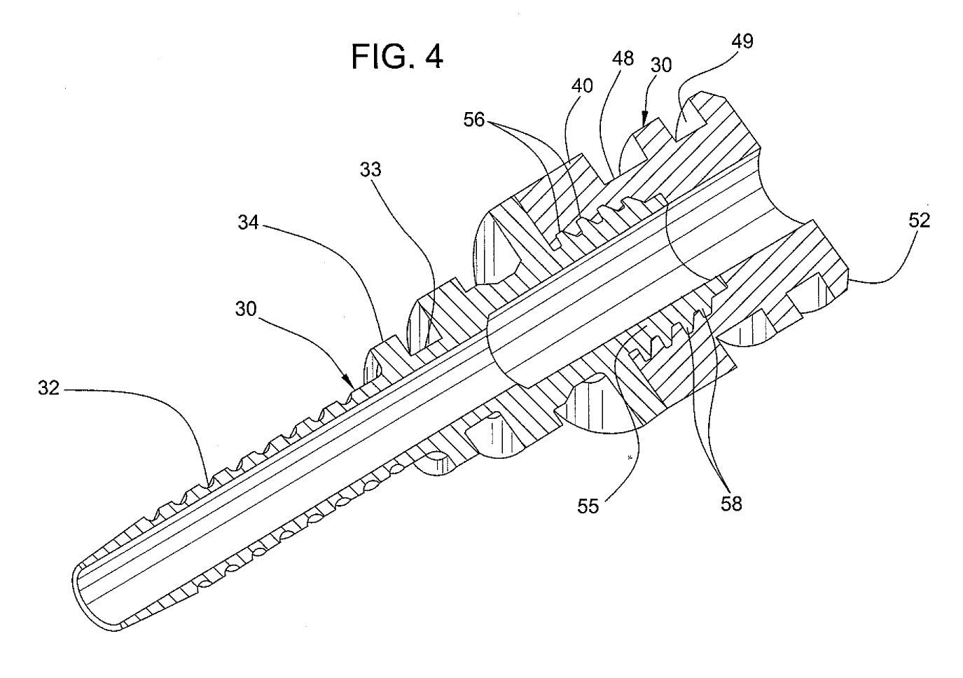

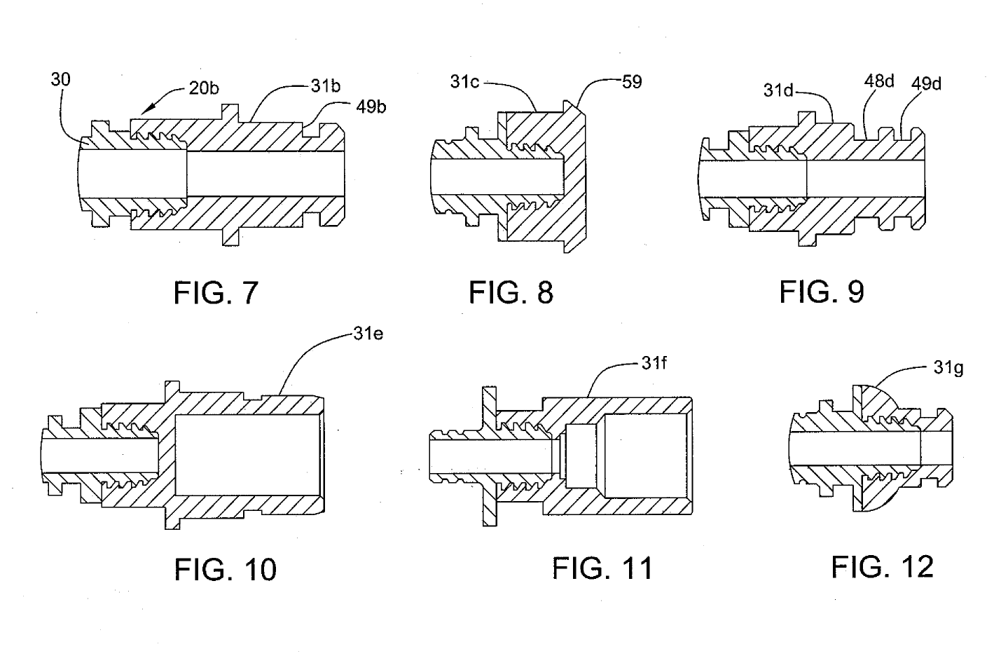

Turning now to FIGS. 7-12, there are shown still further alternative embodiments of overmolded coupling heads that can be used with the universal metal stem 30. FIG. 7 discloses a fitting 20b with a coupling head 31b that has a single O ring groove 49b. FIG. 8 discloses a coupling head 31e in the form of a plug with a chambered closed end 59; FIG. 9, similar to the embodiment of FIG. 2-4, discloses a coupling head 31d with grooves 48d, 49d for a double O ring arrangement; and FIGS. 10-12 disclose fittings other coupling heads 31f, 31g respectively, with alternate designs which are connectable to conventional mating fittings.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A coupling fitting for high pressure hose comprising:
a stem portion made of metallic material for connection to the high pressure hose; and
a coupling head made of a non-metallic material connected to a first end of the stem portion, the coupling head being configured for connection with a mating fitting.

2. The coupling fitting of claim 1 wherein the coupling head is overmolded about the first end of the stem portion.

3. The coupling fitting of claim 2 wherein the coupling head is made of a plastic material.

4. The coupling fitting of claim 2 wherein the coupling head is made of a rubber material.

5. The coupling fitting of claim 1 wherein a second end of the stem portion includes a ribbed shank for insertion into an end of the high pressure hose.

6. The coupling fitting of claim 2 wherein the first end of the stem portion includes retention shank portion over which the coupling head is overmolded and the stem portion has a second end including a ribbed shank for insertion into an end of the high pressure hose.

7. The coupling fitting of claim 6 wherein the retention shank portion includes a plurality of axially spaced flutes each oriented so as to point towards the ribbed shank for retaining the coupling head against axial forces directed away from the stem portion.

8. The coupling fitting of claim 6 wherein the retention shank portion includes an axially extending retention flange about which the coupling head is molded for securing the coupling head against relative rotational torque forces during usage.

9. The coupling fitting of claim 1 wherein the coupling head includes an annular hub having a pair of axially spaced annular grooves each of which receives a respective O-ring seal.

10. The coupling fitting of claim 9 wherein the O-ring seal in one of the grooves has a larger cross-sectional diameter that the O-ring seal in the other groove.

11. The coupling fitting of claim 1 wherein the coupling head includes a pair of rounded seals that are an integral part of the coupling head.

12. The coupling fitting of claim 1 wherein the coupling head is in the form of a plug with a chamfered closed end.

13. The coupling fitting of claim 1 further including a retaining ring assembly that is threadably engageable with an externally threaded head of the mating fitting for drawing the coupling head into captive and secured relation with the mating fitting.

14. The coupling fitting of claim 13 wherein the retaining ring assembly comprises an outer cover made of a plastic material and an inner metal ring.
